(19) United States
(12) Patent Application Publication
(10) Pub. No.: US 2011/0125067 A1
(43) Pub. Date: May 26, 2011

(54) ROLLER FOR SKIN COOLING

(76) Inventor: GIANMARIA COMINATO FILHO, TAUBATE' (BR)

(21) Appl. No.: 12/623,963

(22) Filed: Nov. 23, 2009

(51) Int. Cl. A61H 1/00

(52) U.S. Cl. 601/19

(57) ABSTRACT

“ROLLER FOR SKIN COOLING”, it consists essentially of a roller (1) having a hollow and hermetically closed cylindrical body (2), could be filled with water (A) or fluid propitious to the freezing, having as purpose the cooling of the skin in physiotherapic and/or aesthetic procedures, of easy application.

This patent of Utility Model deals with a new “ROLLER FOR SKIN COOLING”, notably of a piece with ergonomic cable preferentially manufactured in inoxidable material or any another adjusting to its perfect sliding on the skin, having lateral covers for where are placed water or another fluid for freezing for posterior physiotherapic and/or aesthetic application, with greater security and guarantee of the longed result, conferring comfort and security in its handling.

### BACKGROUND OF THE INVENTION

It is known that the physiotherapist/beautician should have a multisectoral vision related to the areas to be worked and/or massaged, as well as the procedures and devices that better adjust to the needs of each case. Beyond the informative character, the main purpose of the professional is to integrate the physiotherapy and the aesthetics, using the physiotherapic resources, aiming satisfactory results in the aesthetic disorders and their prevention. The used aesthetic resources are varied, being since the creativity and ability of the professional until the developed technologies.

It was always common the physiotherapist and/or aesthetic professional uses ice bags for making the massaging of the skin. Already the common user (women) can use the ice bag or container containing water with ice for then immersing the part to be treated inside the container, in order to cool this, generally the face, which is indeed uncomfortable indeed.

In the current state of the technique, there are some patent documents that disclose on the above-mentioned bags as, for instance, the Brazilian application PI0603729-1 that deals with a bag made with in total flexibility material and relative elasticity, the sufficient to generate compression when wrapped in a region of the human body, being said material also selected to produce a good thermal transference to the user; said bag has a closed extremity and the opposite extremity provided with opening that normally is kept closed by closures, and when opened intentionally and by direct interference of the user, it allows the placing of ice or similar in an internal chamber.

This type of solution presents some inconveniences, as the fact of the application time for the procedure of massage of the skin is reduced due to the fast melting of the ice. Another negative aspect is the lack of control in the exposition of the skin, sensible, being able to cause burnings. Another negative point to detach is that, by melting, there is the dripping of water on the user.

The state of the technique also anticipates patent documents that relates to rollers applied to the physiotherapic and/or aesthetic massage as the MU8100875-9U, used in the field of aesthetic utensils. This invention was created to solve problems as located fat, cellulite and flaccidity by local massages. Containing a cylinder, a stem internal to the cylinder of iron, that fits in two cables, and a covering that can be of polyethylene or rubber of several densities, forming protuberances or bristles, said roller presents rolling movements.

PI9900484-4 relates to a massager roller, indicated directly for the prevention of joint damages of inferior members, treatment of damages and muscular reinforcement. Such roller is composed of a central cylindrical axle, which is recovered by a mobile axle with movement independent and delimited by the external borders of the central axle, being said mobile axle composed of four distinct layers.

### BRIEF SUMMARY OF THE INVENTION

As it can be observed, the rollers above do not contain any type of internal fluid, limiting itself to make the massage by pure mechanical contact.

Aware of the state of the technique, its gaps and limitants, the inventor, person active in the mentioned segment, after research and studies, created the “ROLLER FOR SKIN COOLING” that presents particularities enough to become its use more practical and rational, allowing greater security and comfort to the users and professionals of this field.

Basically, the innovation deals with a hollow roller capable of receiving water in its interior that, after freezing, allows its application in the cooling of the skin of the user, perfect for use in physiotherapic and/or aesthetic procedures.

As more preponderant advantages of the innovation, it can be related:
Efficient substitution of the ice bag or bucket;
It propitiates frozen massage for vase constriction and relaxation;
It does not present dripping, beyond providing greater autonomy of time in the procedures;
Convenience and security;
Anatomical product;
It does not use consumable products;
Long useful life.

### BRIEF DESCRIPTION OF THE DRAWINGS

To follow, it is explained the innovation regarding to the attached drawings, in which they are represented:

FIG. 1: View in exploded perspective of roller for skin cooling;

FIG. 2: View in perspective of roller for skin cooling;

FIG. 3: View in cut of roller for skin cooling;

FIG. 4: View in perspective of roller for skin cooling, showing use.

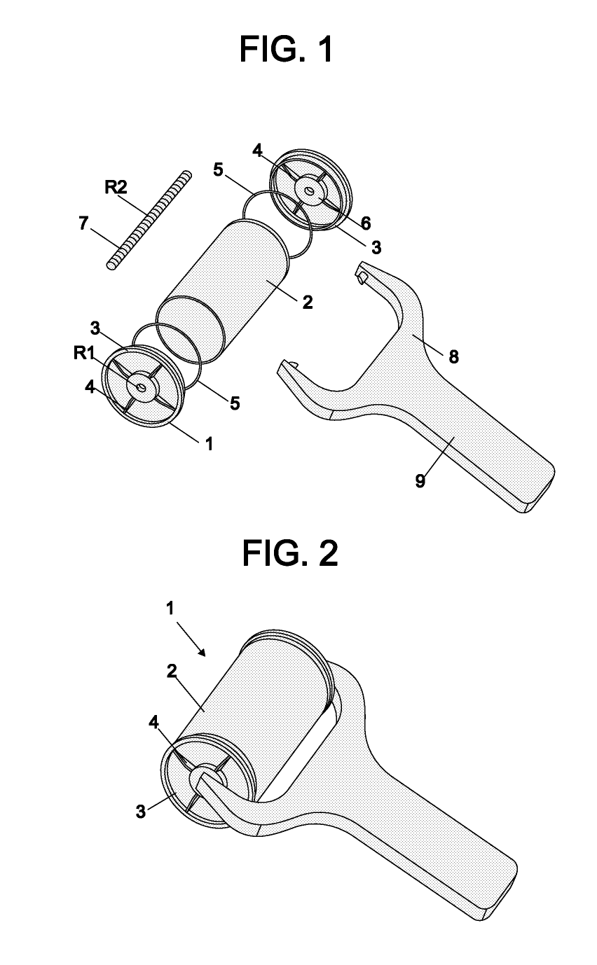

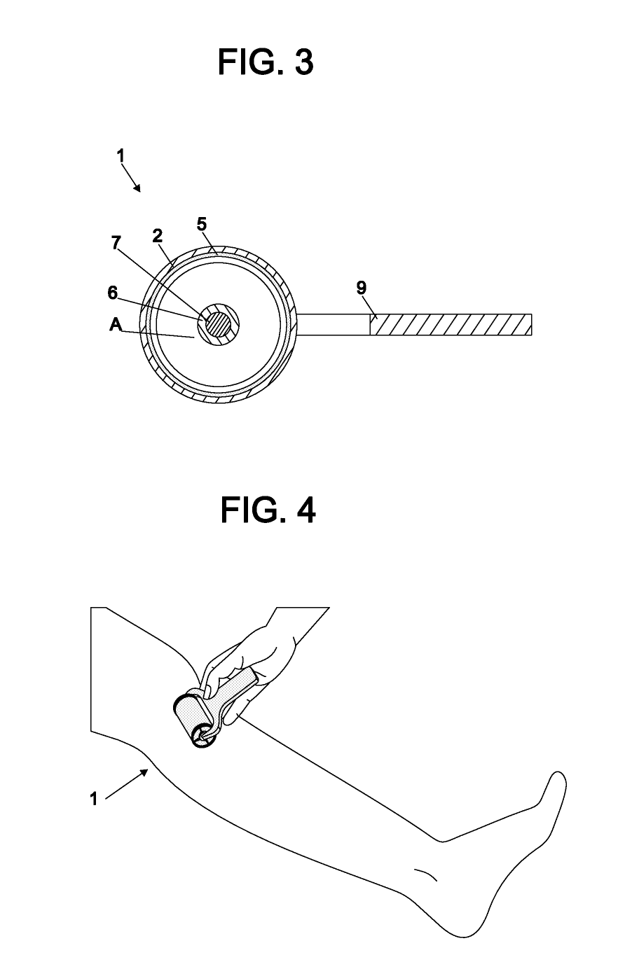

### DETAILED DESCRIPTION OF THE PREFERRED EMBODIMENTS

“ROLLER FOR SKIN COOLING”, object of this patent of Utility Model request, consists essentially of a roller (1) having hollow and hermetically closed cylindrical body (2), could be filled with water (A) or fluid propitious to the freezing, having as purpose the cooling of the skin in physiotherapic and/or aesthetic procedures, of easy application.

More particularly, the roller (1) forms a hollow cylindrical body (2) hermetically closed by means of lateral covers (3) with projections (4) facilitative of opening and closure, having threads (R1) compatible with the extreme threads (R2) of the cylindrical body (2), and between said covers (3) and the faces of said cylindrical body (2), rubberized rings (5) are placed that becomes it stanches, keeping the water (A) to be congealed with no possibility of leaking. On the other hand, the covers (3) form circular headquarters (6) that receive a central screw (7) and the pivots (8) of the anatomical cable (9), what makes possible the radial movement of the cylindrical body (2).

The constructiveness above described as a whole adjusts with ergonomic perfection to the body of the user, characterizing an excellent massager and skin cooler, being the inventive concept in the way as it makes said cooling.

1) “ROLLER FOR SKIN COOLING”, comprising a roller having a hollow cylindrical body hermetically closed by means of lateral covers with projections having threads compatible with the threads of the cylindrical body and between said covers and the faces of said cylindrical body, rubberized rings are provided that become stanches, keeping the water to be congealed; the covers form circular headquarters that receive a central screw and the pivots of the anatomical cable, that makes possible the radial movement of the cylindrical body.
